(19) United States
(12) Patent Application Publication
(10) Pub. No.: US 2010/0332016 A1
(43) Pub. Date: Dec. 30, 2010

(54) VISION GUIDED REAL TIME LOCATING AND TRIMMING OF FLASH

(76) Inventors: Charles A. Abrams, St. Clair Shores, MI (US); Jerry Kuhn, Mayville, MI (US); Mark W. Handelsman, Huntington Woods, MI (US)

Correspondence Address: DICKINSON WRIGHT PLLC, 1875 Eye Street, NW, Suite 1200, WASHINGTON, DC, 20006, US

(21) Appl. No.: 12/822,515

(22) Filed: Jun. 24, 2010

Related U.S. Application Data
(60) Provisional application No. 61/220,381, filed on Jun. 25, 2009.

(51) Int. Cl. B25J 9/02; B25J 13/08; B29C 37/02

(52) U.S. Cl. 700/160; 83/914; 700/204; 700/259; 901/9; 901/47; 901/41

(57) ABSTRACT

A system and method for trimming flash from the body of a workpiece. The system uses a laser system and a vision system to determine quickly a cut line for removing flash from the workpiece. The method includes the steps of projecting a line of light onto the workpiece that crosses the flash and the body and determining the profile of the line in an image obtained by a vision system. The system and method are capable of dynamically trimming while determining where to cut the flash from the body of the workpiece.

### CROSS REFERENCE TO RELATED APPLICATION

This utility patent application claims the benefit of U.S. Provisional Patent Application Ser. No. 61/220,381 filed Jun. 25, 2009, entitled “Vision Guided Real Time Tracking And Trimming Of Flash,” the entire disclosure of the application being considered part of the disclosure of this application, and hereby incorporated by reference.

### BACKGROUND OF THE INVENTION

1. Technical Field

The present invention is directed to a real time system and method of locating and then trimming of flash from molded parts, particularly contoured molded parts, and more specifically to a system and method of touch free measurement of flash, and then trimming the flash from the contoured molded parts.

2. Problem with Existing Technology

Manufacturers form a wide variety of parts or workpieces from plastic, fiberglass, rubber, carbon fiber, composite materials and other materials in molds. These workpieces are typically formed with various amounts of flash that must be trimmed or removed as part of the manufacturing process. In general, flash is commonly known as excess material that overflows or seeps from a mold cavity, particularly at joint lines of the mold. While manufacturers are able to minimize the amount of flash or provide easy markers or lines of where to trim the flash for some workpieces, for others it is very difficult to accurately and repeatably trim the flash. In particular, for very large contoured workpieces, such as boat hulls, windmill blades, shower enclosures, and certain aerospace components manufacturers currently are very limited in their ability to automate the removal of flash, thereby requiring labor intensive processes to remove the flash. Manufacturers are also very limited in their ability to automate the removal of flash from other manufactured parts formed out of multiple molded pieces, each having flash, such as a clamshell design, wherein each half includes flash that adjoins each other and may not be perfectly aligned. In addition for workpieces such as boat hulls and windmill or wind turbine blades, the amount of flash removed may be critical to the performance or integrity of the workpiece. For example, too much material being removed may weaken the structural integrity of the workpiece or reduce the performance of the workpiece while too little material being removed may aesthetically detract from the workpiece or also reduce the performance of the workpiece.

Currently available methods to track and trim flash off of plastic, fiberglass or other molded components use variations of a mechanical touch compliant device such as an air cylinder and some device that physically tracks along a workpiece, such as a earn follower. A cutting tool is offset a specified distance from the compliant device. A robot or other manipulator moves the compliant device along a part following a pre-defined path offset from the flash while the cutting tool tracks along the seam between the parent material and the flash. The compliant device compensates for typical variations between parts so that the robot cuts all of the flash, but does not remove the parent material.

There are two disadvantages of this technology. The first disadvantage is that it is difficult to compensate for gravity. If the part is relatively flat then this is not an issue. If the part has a contour that varies outside of a plane then some method to compensate for gravity must be incorporated into the solution. This is feasible, but adds cost and complexity and is not always as accurate. The second issue is that there is no easy method to compensate for changes in the part contour. Therefore, if the angle between the parent material and the flash changes then this method is not feasible. For some highly contoured workpieces, since the cam or other device is placed a set distance in front of the cutting tool, it is impossible for cam to follow the contour, while also cutting along the desired cut line. Also, variations in the amount of flash, such as the thickness of the flash, which occur with large workpieces make this method not feasible. One more problem with this method is that if the workpiece is formed from combining two molded parts as with windmill or wind turbine blades, each half having flash that abuts together when the workpiece is formed, the compliment device is incapable of determining where to cut if the flash is not perfectly aligned. More specifically, it may cut too little off requiring labor intensive further trimming of the flash or too much such that it affects the structural integrity of the workpiece.

While some solutions for real time tracking of weld seams exist for metal components that are welded together, so far these systems are incapable of being applied to flash trimming. For example, weld seams are easy to spot and follow as they are clearly defined on the surface. In comparison, the flash generally is smooth, part of the surface and it is difficult to determine where the workpiece body ends and the flash starts, and particularly difficult to automate the flash removal process. Therefore, none of theses systems have been able to track, much less track and trim flash. Furthermore, these systems would be incapable of trimming flash where the flash is formed of two abutted flanges, each being flash from a prior molded port that now forms the workpiece.

### SUMMARY OF THE INVENTION

The present invention is directed to a real time system and method of locating and then trimming flash from molded parts, particularly contoured molded parts and more specifically to a system and method of touch-free automated measurement and then trimming of flash.

The present invention uses a vision system to first locate the workpiece and then the start of the flash to be trimmed from the workpiece. The robot positions itself at a desirable position relative to the workpiece, typically within 100-200 mm from the desired start position of initial measurement. The system then projects a pair of crossed lines onto the flash portion of the workpiece to determine the distance of the flash from the vision system, and if applicable to degree of roll or pitch of the workpiece. Any necessary adjustments to the start position are made and then robot system projects a plane of light, forming a line on the workpiece that extends across the flash and the body of the workpiece. Using the resulting line from the projected plane of light onto the workpiece, the system looks for the vertex of the line, which informs the system where the flash and body of the workpiece adjoin, and from this the robot system may determine a cut point, specifically where to cut the flash from the body of the workpiece. The robot then repeats the steps of projecting a plane of light, determining the location of the vertex of the line to determine a cut point, at a previously set and desired distance from the prior cut point determining addition cut points along the length of the workpiece, such that when connected, the cut points form a cut line along which a cutting tool travels to remove the flash from the body of the workpiece.

### DESCRIPTION OF THE FIGURES

FIG. 1 is a perspective end view of a workpiece and a robotic system;

FIG. 2 is directed to an end view of a robotic system and workpiece;

FIG. 3 is directed to a view of an exemplary vision system and light device capable of projecting a plane of light located at the end of the robotic arm;

FIG. 4 is a perspective view of two crossed lines projected on the flash used to calibrate the robot to the workpiece;

FIG. 5 is a perspective view of individual projected lines on the workpiece and the vertex of each line forming a cut point when connected form a cutting path;

FIG. 6 is a perspective view of the intersection of the laser lines on the body and the flash of the workpiece;

FIG. 7 is a second perspective view of the intersecting laser lines on the body and flash of the workpiece;

FIG. 8 is a partial sectional view of an exemplary workpiece and illustrating a robot following a cut line with a cutting tool; and

FIG. 9 illustrates a partial cross section of a misaligned body causing a variation in the alignment of the flash and body of the workpiece.

### DETAILED DESCRIPTION OF THE PREFERRED EMBODIMENT

The present invention is directed to a robotic system 10 and method of trimming flash 120 from the body 110 of a molded workpiece 100. The flash 120 is left over from the molding process of the workpiece 100 and must be removed during the manufacturing process to create a final workpiece 100 or manufactured part. For contoured workpieces and other manufactured parts for which it is desirable or required to have touchless location of the flash for delicate parts or accuracy on certain other difficult to locate the flash portion, this system 10 and method automates a previously labor intensive process and minimizes costly errors during the manufacturing process. The system and method also works extremely well for especially for large, elongated workpieces. The workpiece 100 as illustrated in the Figures is a large windmill or wind turbine blade, which may reach lengths of one hundred meters or more and are extremely costly to manufacture in both materials and labor. Until now, windmill blades were incapable of having the molding flash 120 removed from the body 110 accurately and precisely in an automated fashion. Of course, the present invention is also applicable to any other molded parts or other parts which include flash that must be removed from the body of a workpiece.

Although the robotic system be fixed in place, and the workpiece may be sized to be within reach of the robotic arm 40, it is preferable for large or elongated workpieces that the robotic system 10 includes a mobile platform 12 which allows the robotic system 10 to travel along the elongated workpiece 100. The mobile platform 12 in the preferred embodiment generally includes a platform 18 and, wheels 16 which run on rails 14 set on the floor. Of course, the system 10 may be formed with other variations of mobile platforms such as a platform that is suspended from the ceiling. In some embodiments, the system 10 may even be made without a mobile platform and the workpiece 100 may move relative to the robotic assembly. Given the expected length of the workpieces 100 such as windmill or wind turbine blades, it is generally preferable to move the robotic assembly 10 relative to the workpiece 100 instead of the workpiece moving relative to the robotic assembly in that substantial additional manufacturing space is needed to move the elongated workpieces past the robotic assembly. Also, moving the workpiece 100 is time-consuming and may require stopping of the robotic automated process while the workpiece 100 is being moved and then restarting the process, which may require additional calibration steps by the robot 10 to ensure the location of the moved workpiece 100.

The robotic assembly 10 includes a base 30 securely attached to the mobile platform 12 or to a solid surface if the mobile platform 12 is not included. A robotic arm 40 extends from the base 30. The arm 40 is preferably at least a six axis arm to maximize the maneuverability of the arm 40 and allow for minute variations while trimming the flash 120. Of course, other styles and robotic arms may be used.

The robotic arm 40 terminates in an end effector 50 that holds a measurement system 52 and cutting tool 80. The measurement system 52 and cutting tool 80 are described in more detail below and may form part of the end effector 50 or be attached to or coupled to the end effector 50. The end effector 50 may vary in style, shape and size but generally needs to securely hold the measurement system 52 and cutting tool 80 in their desired positions to maximize accuracy and precision during the trimming of flash 120. More specifically, the end effector 50 generally has first extent 54 and a second extent 56, which is generally perpendicular to the first extent 54 to properly space the two parts of the measurement system 52 from each other and the cutting tool 80, as well as the measurement system 52 from the flash 120. As illustrated in the Figures, the end effector 50 may simply be bars attached to the robotic arm that holds the measurement system 52 and cutting tool 80 in place. In other embodiments, not shown, the end effector 50 could simply be a frame to which the measurement system 52 and cutting tool 80 are attached. The end effector 50 may be attached to the robotic arm 40 in a permanent fashion or may be simply picked up by a robotic arm 40 having a clamp (not illustrated). While a variety of styles of end effectors 50 may be used, and may vary depending on the type of workpiece, the end effector 50 must be configured to properly position the measurement system 52 relative to the cutting tool 80, and allow for uninterrupted locating and removal of the flash.

The measurement system 52 generally includes a vision system 60 or camera and a laser device 70 to properly measure where the flash 120 must be trimmed such that only flash 120 is trimmed and that the cutting tool 80 does not score or dig into the body 110 of the workpiece 100. While the end effector 50 is illustrated as placing the measurement system 52 displaced along the second extent 56 from the cutting tool 80, in some embodiments they could be aligned such that no distance separates them along the second extent 56. However, to provide the real time tracking and updating particularly of both sides of the flash, the measurement system 52 would need to be focused ahead of the cutting tool in the direction of cutting such that sufficient time is allowed for adjustments of the positioning of the cutting tool and to allow ease of locating the flash to be removed and more specifically, the cut line along with the cutting tool 80 must travel, without interference from the cutting tool 80 during removal of the flash.

The measurement system 52 as discussed above includes a vision system 60 and a laser device 70. For workpieces 100 formed from two halves or multiple pieces, with common flash, the two halves may displaced relative to each other, so for such workpieces it is desirable to use two measurement devices, one for one side of the flash 120 and the other for the other side of the flash 120, as illustrated in the Figures. Of course, for workpieces where only a single flash layer is to be trimmed from the body or where the flash 120 is typically consistent, it may be possible to use only one measurement device, which may be located on the same or opposing side of the flash 120 as the cutting tool 80. The vision system 60 may be any optically capable system 60 that process 2D images. As illustrated in the Figures, the vision system 60 is formed from a 2D camera which takes an image of the workpiece, particularly the body 110 and flash 120 and more specifically, the location of at least one projected laser line on the workpiece, illustrated as either 72 and 74 in the Figures.

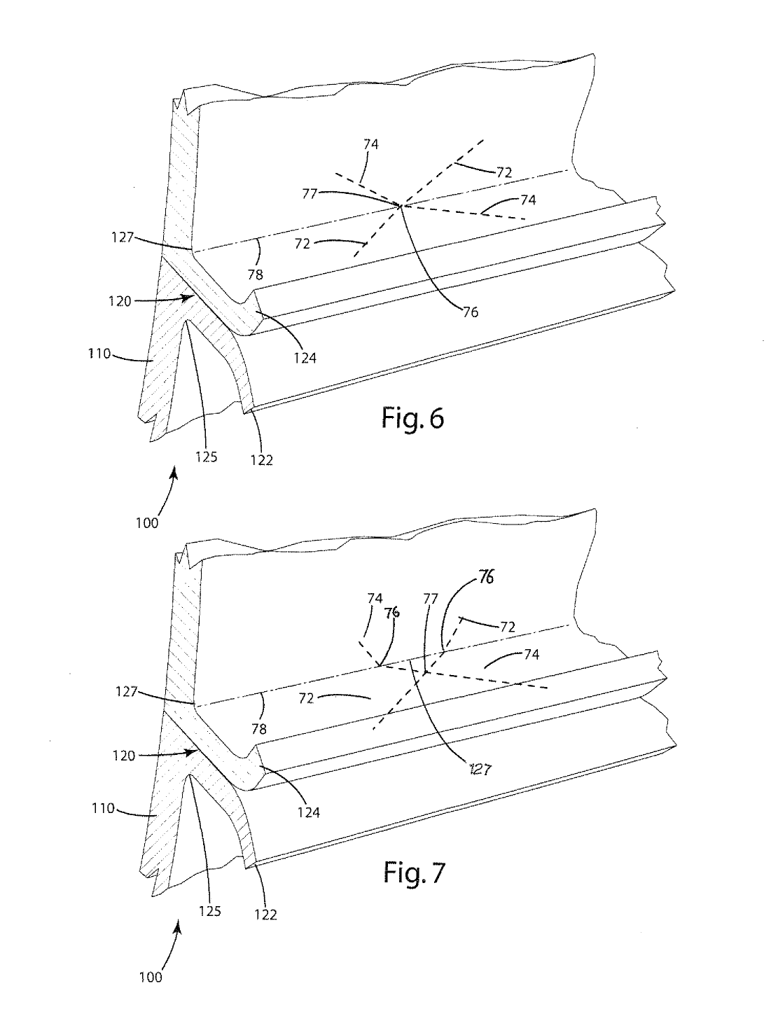

The laser device 70 is capable of projecting at least two planes of light toward the workpiece, which show up on the workpiece as the illustrated lines 72, 74. As illustrated in FIG. 5, a single laser line 72 or 74 may be used, or as further illustrated in FIGS. 6 and 7, two laser lines may be used, which intersect at the intersection point 77. Due to the typical configuration of the flash 120 relative to the body 110 of the workpiece 100, the lines 72, 74 will as illustrated in FIGS. 5, 6 and 7 include a vertex point 76, such as the vertex of an open shaped “V”. The laser device 70 is any laser device capable of projecting the planes or other forms of projected light to create at least one laser line that extends across the flash 120 and the body 110 of the workpiece 100. The laser device 70 illustrated in the Figures simply oscillates a laser to create a line 72 or 74 that is visible to the vision system. The use of a second line 72 or 74 as illustrated in the Figures is useful during calibration, as described below. The second line 72 or 74 is also useful as a secondary check or allow for selection of the best line by the vision system 60 if one of the laser lines is distorted at a point due to debris on the workpiece or mold issues that distort the profile of the intersection of the flash 120 and body 110. It should be recognized that for certain curved, contoured or other varied profile workpieces, the profile of the lines 72, 74 may vary along the length of the workpiece 100. These profile changes also change the angle of the line segments formed by the vertex point 76 on a particular line. In addition, it should be recognized that, if two laser lines are used, the angle of intersection formed at the intersection point 77 may vary as desired. It should be recognized that while the present invention is illustrated and discussed herein as using a laser device, other light producing devices that are capable of providing a defined line on the surface of the workpiece with the desired accuracy may be used in place of the laser device and should be considered within the term “laser device” as used herein and the claims.

The cutting or trim tool 80 may be any tool capable of cutting the flash 120 from the workpiece 100, typically a circular blade, or a router bit system (not shown) that is capable of cutting smoothly through the flash 120 to separate it from the body 110 of the workpiece 100 while yet providing a smooth, consistent cut path a desired distance away from the body 110 of the workpiece 100.

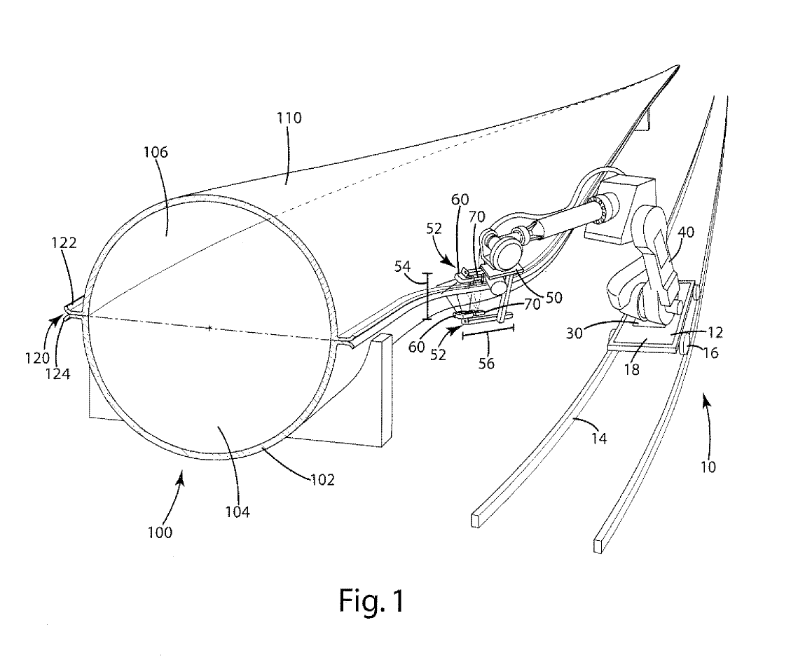

As illustrated in detail in the Figures, the workpiece 100 is a windmill or wind turbine blade 102. These elongated blades are typically formed as first half 104 and second half 106 shells in a mold. The two shells 104, 106, as illustrated in FIG. 1, are then brought together and formed together into a single workpiece 100. What remains from the molding process is flash 120 extending from the body 110 of the workpiece 100 on each of the two shells 104, 106. While the drawings illustrate directly two opposing portions of flash, in some embodiments additional occurrences of flash 120 or even less occurrences of flash may occur depending upon the workpiece and the manufacturing process used. As illustrated in the Figures and discussed herein, for workpieces 100, the flash 120 is that which needs to be trimmed from the body 110. For ease of illustration and discussion herein, when two individual shells or portions are combined into a single workpiece and each individually include flash (that could be trimmed individually before placing the shells together), the then combined individual flash members are then called flash (the portion to be trimmed) with previous individual flash members now being referred to as individual flanges forming the flash of the combined parts. More specifically, the flash is always the portion that must be trimmed, and if the flash is formed from multiple pieces, those are called flanges, even if when separated they could be trimmed as flash.

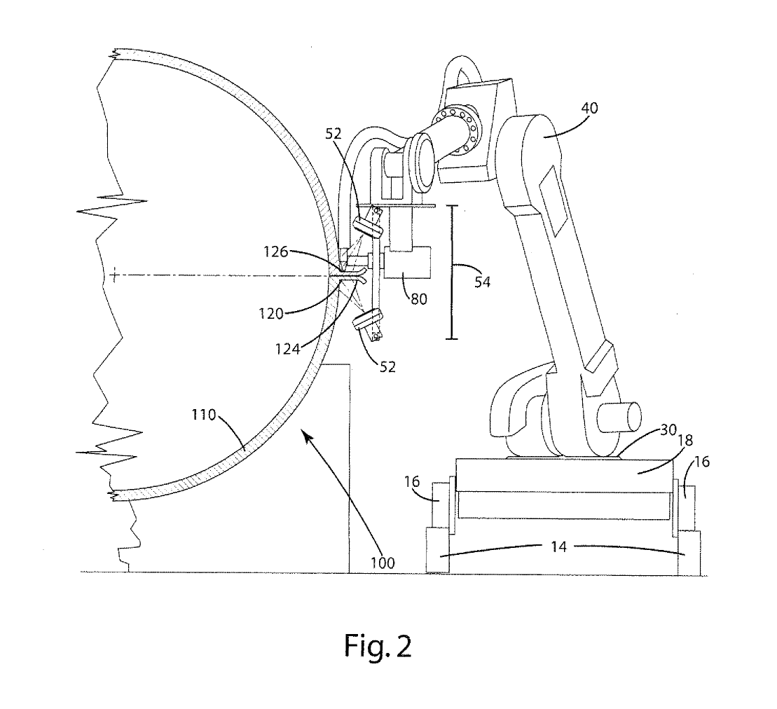

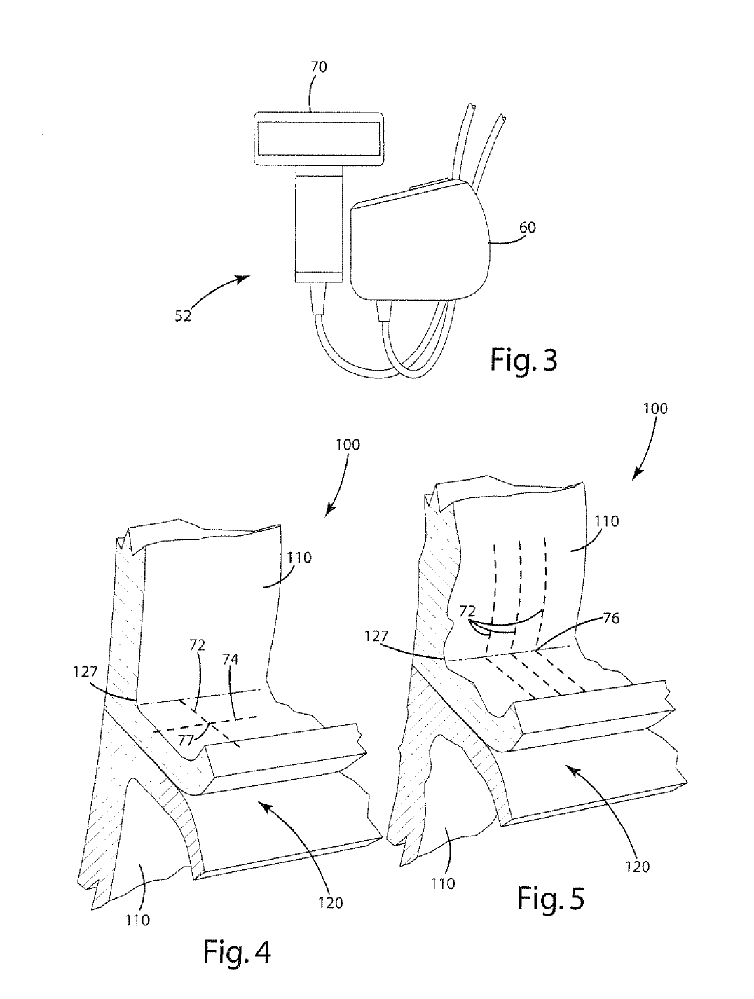

As further illustrated in FIG. 2 and other Figures, where the body 110 and the flash 120 meet generally includes a first curve or first radius 125 on one side of the flash 120. If the flash 120 is formed from two flanges 122, then the opposing side includes a second curve or second radius 127. Typically, these individual flanges are aligned as illustrated in FIG. 2 such that trimming provides an equal distance to the body from the trimmed edge left once the flash is removed. More specifically, when the flash is trimmed from aligned parts, allowing a smooth transition between the two halves once trimmed, the system 10 attempts, depending upon the desired design restrictions, to typically form as smooth as a transition as possible between the shells of the body, allowing for a smooth surface on the workpiece 100 without additional processing. However, in some embodiments the curves 124, 126, as illustrated in FIG. 9, may be misaligned such that one flange 122 of the flash 120 extends further than the other flange 122 such that the first and second curves 124, 126 are misaligned or offset from each other. The offset distance 128 is further illustrated in FIG. 7. When the two halves are not aligned, the system 10 trims the flash along the best determined cut line, as further discussed below while trying to not damage the body 110.

The measurement system 52 is generally positioned to obtain optimal reading by the vision system 60 and projection of lines 72, 74 by the laser device 70. This optimal position may very depending on the make, model or configuration of the vision system 60 and laser device 70. For example, the measurement system 52 was generally positioned at 30° to 60° degrees relative to the flash 120 where the outwardly extending flash is at 0°, and more specifically at and preferably 45″. By placing the vision system 60 at a distance of approximately 100 to 1000 mm, preferable 300 mm to 500 mm away combined with the above desired angle and on each side of the flash, allows the vision system 60 used in the illustrations an accurate view of the first curve radius and second curve radius of the flash against the body 110 of the workpiece 100. Of course, the distance of the vision system 60 from the workpiece 100 may vary depending upon the design specifications of the vision system, such as the focal distance of a 2D camera if the focal distance is a set distance. As the measurement system is measuring the shape and profile of one of the projected lines 72 or 74, any desired placement that provides accurate reliable and precise location is acceptable.

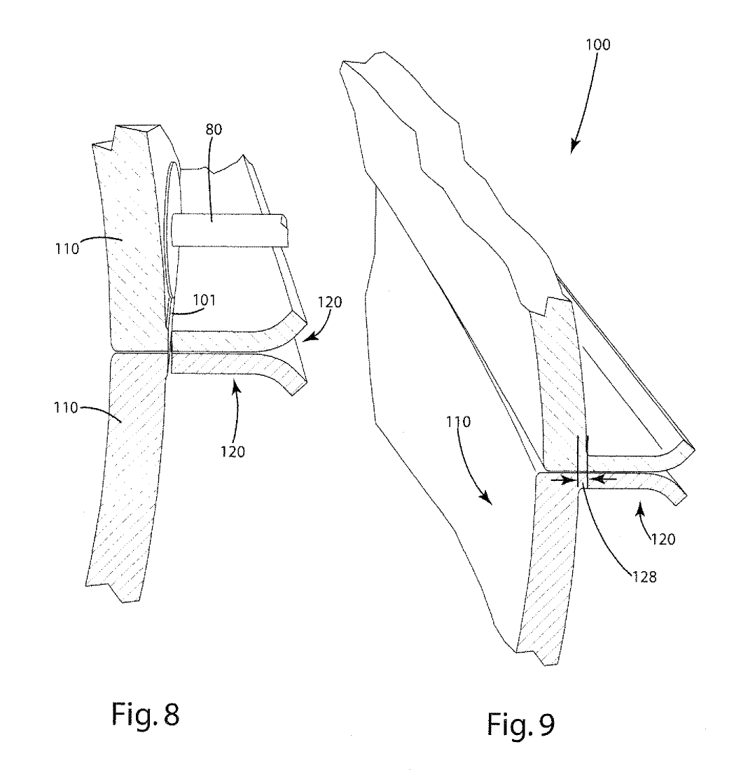

The measurement system 52 determines the location of the desired cut line 101 using the vertex point 76 of at least one of the projected lines 72, 74. For clarity, it should be understood that the vertex point 76 and the illustrated bend at the vertex point 76 is not produced by the laser device 70, but instead occurs from the profile of the intersection of the flash 120 and body. Therefore, the measurement system 52 may determine the cut point to be at the vertex point 76, inset slightly from the vertex point 76 or spaced a distance away from the body from the vertex point 76. The exact location of the cut point relative to the vertex point 76 depends on the desired specifications and design and is programmed by the user. In addition, the spacing of the cut point from the vertex point 76 may vary along the length of a workpiece. For example, where the intersection of the flash 120 with the body has a sharp curve or small radius 125, 127, the cut line may be at the vertex point, or slightly outward of the vertex point, but when the curve is more gradual or a larger radius 125, 127, the cut point may be inset from the vertex point. As further described in detail below, it should be recognized that multiple cut points are gathered to create a cut line 101 followed by the cutting tool 80. An exemplary cut line 101 is illustrated in FIG. 8, with the cutting tool 80 following the cut line 101. The cut line 101 illustrated in FIG. 8 is set at an exemplary distance, and the placement of the actual cut line could vary depending on the desired design specifications.

The present invention is based on locating an image formed by a projected line of light or light stripe, or forming lines 72, 74 on the surface and the vertex point 76 that is viewed by the vision system 60. The laser device 70, if it is a laser, moves the projected laser back and forth so that the line of light generated forms a plane. The laser 70 is tilted with respect to the vision system 60 so that the image seen by the vision system 60 is the intersection of the plane formed by the laser light and any part that is in the view of the vision system.

By calibrating the laser planes that form the illustrated lines 72, 74 with respect to the image seen by the vision system 60, each point along the lines 72, 74 can be defined as a specific X,Y,Z coordinate. So if a section of the workpiece 100 with flash 120 is viewed by the vision system 60, as lines 72, 74 on the surface are imaged by the vision system 60, and the X,Y,Z position of each point along that line can be determined.

As the robot arm 40 or other manipulator moves the laser 70 and vision system 60 along the path of the flash 120, the vision system 60 images the vertex of the Vs 76 to determine individual cut points that are combined into a cut line 101. The cutting tool 80 is set back from the section of the flash that is in view of the vision system 60. The robot 10 then moves the cutting tool 80 along the cut line 101 determined by combining the determined cut points. As the robot is moving the cutting tool 80 along the cut path 101, the vision system 60 images the projected lines 72, 74 ahead of the path of the cutting tool 80 to determine the next cut point. Therefore, the system 10 may cut as it locates the cut line 101, allowing the flash 120 to be located and trimmed from the body in a single pass.

For some molded parts the profile between the body 110 and the flash 120, such as the profile and measurement of each radius 125, 127, can vary along the part. This means that the shape of the projected lines 72, 74 and particular the angle at the vertex point 76 can change along the length of the workpiece 100. For a wind turbine blade the profile of the flash seam near the root end of the blade forms close to a 90 degree angle at the first and second curves as illustrated in FIGS. 1, 2, 4 and 5 while the profile of the flash seam specifically the curves near the tip 11 is almost flat (not illustrated). The measurement system 52 can compensate for this variation in the profile of the imaged line 72, or 74 by knowing approximately where the robot 10 is along the length of the workpiece 100 and select from a preloaded profile schedule the shape of the V that it needs to look for, however this step is optional. To provide accurate measurements, the known shape does not have to exactly match the shape of the part, but instead is useful to provide a rough representation so that the vision system can easily, accurately and precisely determine the vertex point 76 and thereby the cut line.

As mentioned above, for certain large workpieces such as wind mill turbine blades, two molded sections are laminated together. Both the sections each have their associated flash 120, specifically a flange 122. Due to normal manufacturing tolerances the top and bottom molded sections do not always fit perfectly together or may be misaligned and their associated flanges 122 can be slightly off from one another. When trimming these misaligned workpieces, both sides of the flash 120 must be located and measured separately so that the robot follows along the outer most of the two flanges 122. The robot compensates for this by having two separate measurement devices that form the measurement system, or more specifically two pairs of vision system 60 and laser device 70 with one pair of laser device 70 and vision system 60 tracking one side of the flash and the other pair of laser device 70 and vision system 60 tracking the other side of the flash. Since the vision system can measure the exact location of each flange 122 of the flash 120, it can determine which of the two flanges of the flash to use for determining the cut point. Of course, as the robot system 10 moves along the length of the workpiece, the selected cut point may change from side to side to accommodate the manufacturing tolerances.

To set up the process, the robot system 10 calibrates the vision system 60 and associated laser device 70, as well as output planes of light that form the lines 72, 74 to the robot. Calibration of the robot system 10 is expected to be a one-time procedure that only is done during the initial setup. Of course, if discrepancies are noticed, the system 10 may be recalibrated.

The method generally starts by the robot system 100 first using the vision system 60 to get an initial and approximate location of the workpiece 100 and where the flash 120 begins. This allows for variation in the placement of the workpiece 100 relevant to the location of the robot system 10. More specifically, large workpieces 100 such as wind turbine blades are very difficult and cumbersome to move and are therefore very difficult to place accurately and precisely each time. Therefore, the manufacturing process is more efficient if the workpiece may be approximately placed and the robot system 10 can automatically determine where to start the process. This step of determining the initial location provides a starting point for positioning the vision system 60 and laser device 70 relative to the workpiece to begin scanning the flash 120 and is not used to determine the cut line. The workpiece only needs to be at least partially in the field of view of the vision system 60 and does not have to be precisely fixtured or located by other means which allows for a wide variation in the location of each workpiece 100, relative to the robot system 10.

Once the initial location of the workpiece is determined, the system 10 determines where to move, if included the mobile platform 12, and the robotic arm 40 so as to place the measurement system 52 in an acceptable position to being locating the flash 120. Again, the robotic system accomplishes this placement or step of determining the initial end effector position automatically and without external input.

To further adjust the robot to the flash 120, specifically the measurement device(s) 52 and cutting tool 80, the laser device 70 may optionally project intersecting lines 72, 74 onto the flash 120 to determine the plane of the flash 120 accurately including the degree of roll or pitch of the workpiece to fine tune the placement of the measurement device(s) 52 and where to project the at least one lines 72 or 74 to determine the cut point, as illustrated in FIG. 4. The 2D vision system is also able to see the abrupt end of the flash to determine the necessary location information. As part of determining the position of the flash, as the system knows the distance that the laser device 70 is spaced from the vision system 60 and the angle of the projected light from the laser device 70, variations in the position of the line 72, 74 along the length of the flash may be used to determine the distance away of the flash 120. For example, if the laser device is on the right side, and the vision system on the left side, and the laser device projects the light downward and the left, the further to the left the light shows up as the line 72, 74 on the flash, the further the distance of the flash 120 from the measurement system 52. Likewise, the further to the right the line is located, the closer the flash to the measurement device 52. Given that the measurement system 52, knows the distance separating the vision system 60 and laser device 70 and the angle of projection of the light from the laser device, the vision system 60 can be used to accurately determine the position of the flash depending upon the location of the line on the flash 120.

With the position of the workpiece 100 relative to the arm 40 or measurement device 52 determined, the system 10 can place the measurement device 52 within 100 mm to 200 mm of the start position, although this distance may vary, to start determining the cut points, as is illustrated in the Figures. Near the ends of the workpiece, such as the illustrated root end of the wind turbine blade in FIG. 5, it is expected that the projected line will be approximately perpendicular to the elongated intersection of the flash 120 and body 110, to provide a line of sufficient length on each side of the vertex point 76 for the vision system to measure. Of course, as the robot takes subsequent cut points and moves along the workpiece, it may be desirable for the lines to be angled other than perpendicular to the intersection of the flash 120 and body 110, such as illustrated in FIGS. 6 and 7. More specifically, the laser device 70 may adjust the angle of the line 72, 74 to allow for easy determination of the vertex point 76, and the profile of the line 72, 74. Of course, the angle of the line 72, 74 relative to the intersection of the flash and body may vary depending upon the curve 125, 127, location along the workpiece or other considerations, so long as the vision system can accurately determine the vertex point, profile of the lines and determine the cut points therefrom.

The robot system 10 then takes an image of at least one flange 122 of the flash 120, or one side of the flash, and if desired, the other flange 124 or other side of the flash 120. Each laser device 70 projects at least one the laser line 72, 74 onto the workpiece 100 and each vision system 60 locates the vertex of the V 76 for both of the first and second images, each image corresponding to one of the flanges 122, 124 of the flash 120, giving two opposing vertex points 76. With the robot 10 and measurement system 50 already calibrated, the exact X,Y,Z position of these two vertex points 76 can be determined. To accurately determine location of variable contoured flash, the system 10 may as part of the step of determining the cut line refer to stored profile images of profiles of the flash 120 to assist with locating or positioning the vertex 76 and subsequently locating the cut line.

Using the two location points, the robot system 10 may determine if the points are opposingly aligned. If the points are not aligned, the robotic system 10 will typically select one of the two points that extends furthest out to ensure that the robot only trims the flash and does not cut into the body of the part. However, other selections depending on the desired design of the workpiece may use other configurations, such as a distance from the selected point, or if desired an average or some other combination of the points or distance therefrom as the location of the cut point, which will be used in determining a cut line. The robotic system 10 then moves along the flash 120 repeating the above measurement and selection steps, such that a continuous cut line is determined along the flash 120. Of course, the system does not actually need to determine a cut line, but may simply direct the cutting tool from one cut point to the next cut point.

As the robot system 10 moves roughly along the cut line and taking subsequent measurements, the robot's cutting tool 80 follows some specified distance behind. More specifically, the robot system knows how far behind the currently being measured point and adjusts the cutting tool 80 to pass through the relevant previously measured points. As the robot is moving along this path it continues to take additional images of the laser cross section to determine the next points that form the cut line on the flash 120. The robot then follows the path to these points while taking an image of the next laser line cross section which then becomes the next point along the path. This real time tracking and cutting process continues all the way along the workpiece.

The robotic system may each time or only periodically check each side of the flash to confirm which to use as the basis for the desired cut line. If it reaches a point where there is a transition between which side to use then the robot switches to the new outer most section.

The present invention can follow along molded parts with significant changes in contour such as windmill or wind turbine blades. For windmill or wind turbine blades, the profile between the parent material and the flash at the root of the blade is approximately 90 degrees while at the tip of the blade the profile is almost flat, which makes it impossible for a cam follower or air piston to be used in accurately and precisely trimming of the flash. The present invention can also track along parts with curvature. Windmill or wind turbine blades curve out in the middle of the blade and then curve back in towards the tip.

1. A robotic system for locating flash on a workpiece and then trimming the flash from the workpiece, said system comprising:
a robotic arm;
an end effector coupled to said robotic arm, said end effector having a first extent and a second extent;
a first vision system including a first 2D camera coupled to said end effector and a second vision system including a second 2D camera coupled to said end effector and spaced a distance away from first vision system;
a first laser device coupled proximate to said first vision system and a second vision system coupled proximate to said second vision system, and wherein each of said laser devices is capable of outputting at least one plane of laser light through oscillation of a laser in said laser device toward a workpiece to create a line of light on the workpiece and wherein each of said 2D cameras are capable of obtaining an image of the line of light where the plane of laser light intersects the workpiece and at least two of the X,Y,Z coordinates of points along the line of light on the workpiece;
a controller for determining cut points and
a cutting tool disposed between said first vision system and said second vision system along said first extent, and disposed away from said first and second visions systems along said second extent wherein said cutting tool is directed to cut along the determined cut points.

2. The system of claim 1 further including a mobile base and wherein said robotic arm is coupled to said mobile base.

3. A method of trimming flash from the body of a workpiece with a robotic system having a robotic arm, said method comprising the steps of:
locating the workpiece,
positioning the robotic arm relative to the workpiece;
projecting light from at least one light source coupled to the robotic arm toward the workpiece and wherein said light source creates a projected line on the flash and body of the workpiece;
obtaining an image of the projected line on the workpiece;
determining the profile of the line on the workpiece;
determining a cut point using said profile;
repositioning the robotic arm to a next measurement position; and
determining a cutting path through multiple cut points by repeating each of said steps of projecting light, obtaining an image, determining the profile and determining a cut point; and
removing the flash by directing a cutting tool along the determined cutting path.

4. The method of claim 3 wherein said step of positioning the robot relative to the workpiece includes the step of obtaining an image of the workpiece using a vision system coupled to the robotic arm.

5. The method of claim 4 wherein said step of positioning the robot relative to the workpiece further includes the step of moving the robotic arm to a starting position, based upon the image obtained during said step of obtaining an image of the workpiece.

6. The method of claim 3 further including the step of projecting intersecting lines of light on at least one side of the flash, before said step of projecting light.

7. The method of claim 6 further including the steps of obtaining an image of the intersecting lines of light with a vision system coupled to the robotic arm and determining the location of the intersecting lines of light relative to a vision system.

8. The method of claim 6 wherein said step of determining the location of the intersecting lines of light further includes the steps of determining the degree of roll of the workpiece and the x,y,z coordinates of at least one point on said intersecting lines of light.

9. The method of claim 6 wherein in said step of projecting intersecting lines of light on at least one side of the flash, further includes projecting at least one of said intersecting lines across an outer edge of the flash.

10. The method of claim 3 wherein said flash has a first and second side and wherein said step of projecting light toward the workpiece includes the step of creating projected lines of light on each of said first and second sides of the flash.

11. The method of claim 10 wherein said step of obtaining an image further includes the step of obtaining an image of said projected lines on each side of the flash.

12. The method of claim 11 wherein said step of determining the profile includes the steps of determining the profile on each projected line on each side of the flash.

13. The method of claim 12 wherein said step of determining the profile further includes the step of determining a vertex point on each of said projected lines on each side of the flash.

14. The method of claim 13 wherein said step of determining a cut point further includes the step of comparing the location of each vertex point and selecting one of the vertex points to be used in determining a cut point.

15. The method of claim 14 wherein said step of determining a cut point further includes the step of selecting the location of the cut point relative to the selected vertex point.

16. The method of claim 13 wherein said step of determining a vertex point further includes the step of comparing the determined profile to a stored profile selected from stored profiles.

17. The method of claim 3 wherein said step of determining a profile further includes the step of comparing the determined profile to a stored profile selected from stored profiles.

18. The method of claim 17 wherein said stored profile is selected from said multiple stored profiles be determining the position of the robotic arm relative to the workpiece.

19. The method of claim 3 wherein said step of determining a profile further includes the step of determining the vertex point of the projected line.

20. The method of claim 19 wherein said step of determining a profile further includes the step of determining the angle of line segments of the projected line on each side of the vertex point in the obtained image.

21. The method of claim 19 wherein said step of projecting light further includes the step of projecting a liner line of light.

22. The method of claim 30 wherein said step of determining a profile further includes the step of selecting the relevant vertex point when multiple vertex points are present.
